(19) United States
(12) Patent Application Publication
(10) Pub. No.: US 2025/0224581 A1
(43) Pub. Date: Jul. 10, 2025

(54) WATERPROOF FIBER DOME SYSTEM AND ENCLOSURE

(71) Applicant: OSP Solutions LLC, Asheville, NC (US)

(72) Inventors: Jackie Brook Lunsford, Asheville, NC (US); Zachary Michael Shiflett, Asheville, NC (US)

(73) Assignee: OSP Solutions LLC, Asheville, NC (US)

(21) Appl. No.: 19/016,463

(22) Filed: Jan. 10, 2025

Related U.S. Application Data
(60) Provisional application No. 63/619,433, filed on Jan. 10, 2024.

(51) Int. Cl. G02B 6/44

(52) U.S. Cl. CPC G02B 6/4444

(57) ABSTRACT

Enclosures for cable, by way of example, dome-type enclosures are shown and described. In one embodiment, the invention may be considered a waterproof sealing mechanism for dome enclosures. The invention may be considered an enclosure including a dome, and a base. The base may include a thread cap that may be hand-tightened to provide a compression along an outer perimeter face of a seal member to create a waterproof seal for the dome enclosure.

### FIELD OF THE TECHNOLOGY

The present disclosure relates generally to enclosures, more specifically dome-type enclosures, and more particularly to improved sealing apparatus, systems, and mechanisms for dome enclosures for fiber/cable connection.

### BACKGROUND

Dome type enclosures, also sometimes known as optical cable joint enclosures, also known as optical cable connection packages, and optical cable joint packages and domes, are conventionally suitable for various structures of optical cable overhead, pipeline, and/or direct buried laying methods of direct and branch connection.

Such dome enclosures are intended to be waterproof in order to protect the contents of the enclosure, with long lifespans and subject to be opened and closed multiple times over the lifespan of the dome enclosure. Applicant realizes that repetitive use and long-term exposure can lead to leaks and failure in the conventional systems. Some enclosures protect and enclose cables, for example spliced cable terminus.

Further, Applicant realizes that traditional dome enclosures are difficult to re-access over time, and even more difficult to maneuver to open the enclosure to add additional cable when cable is already present in the dome. Such enclosures, are further difficult to re-seal to obtain waterproofing for the contents repetitively when the dome enclosures are opened and closed repeatedly over the lifespan of the enclosure.

Some effort to address challenges in the conventional domes have made attempts to seal the optical cable through a rubber sealing ring, through pressurized sealing, and/or using springs to generate a seal. However, after a long time of use, sealing ring often have a certain degree of wear, reducing the sealing ability, springs wear and lose compression, etc. so that the sealing effect may be poor or compromised over time.

Further, these types of sealing structures are difficult to access repeatedly. Therefore, Applicants desire systems, devices, and methods for dome enclosures to improve durability, waterproofing, and sealing without the drawbacks presented by the traditional systems and methods.

### BRIEF OVERVIEW

This brief overview is provided to introduce a selection of concepts in a simplified form that are further described below in the Summary and Detailed Description. This brief overview is not intended to identify key features or essential features of the claimed subject matter. Nor is this brief overview intended to be used to limit the claimed subject matter's scope.

Various embodiments of the inventions provide systems assemblies, apparatus, and methods for improved enclosures without the drawbacks presented by the traditional systems and methods.

As non-limiting examples, in an enclosure including a dome and a base assembly, allows for a seal member to create a waterproof seal for the dome enclosure.

In another non-limiting example, an enclosure includes a dome and a base, the base including a thread cap able to be hand-tightened (and requiring no tools), the hand-tightening creating a compression pressure along a perimeter face of a seal member to form a waterproof seal for the dome enclosure.

In further non-limiting examples, a dome and base enclosure may include a sealing gel member.

In yet further non-limiting examples, an enclosure system may include a dome and a base attached to the dome. The base may include a base member, a cap, and a seal member. The base may form a watertight seal for the dome enclosure when a threaded cap is attached to the base.

Examples may include a dome enclosure kit. A dome enclosure kit may include a waterproof seal assembly between a dome and a base. Methods for waterproofing an enclosure, by way of example, a dome enclosure, are considered with the scope of the disclosure according to combinations of any of the embodiments herein and/or understood from the present disclosure.

The foregoing brief overview, along with the following summary and detailed description provide examples and are explanatory only. Accordingly, the foregoing brief overview and the following summary and detailed description should not be considered to be restrictive. Further, features or variations may be provided in addition to those set forth herein. For example, embodiments may be directed to various feature combinations and sub-combinations described in the summary and detailed description.

### SUMMARY

In accordance with the present disclosure, waterproof dome enclosure devices are provided for waterproof containment of optical cable. This disclosure provides improved dome enclosure systems, methods, and devices that are convenient, durable, and efficient for the user, particularly when used to encase optical cable and the like.

One embodiment of the present disclosure includes a waterproof dome-type enclosure including a dome, a base and thread cap. The dome may be affixed to the base. The base may be affixed to the thread cap on an opposite side of the base interface with the dome. The dome may make up an upper portion of the dome enclosure. The base may make up an intermediate portion of the dome enclosure. The thread cap may make up a lower portion of the dome enclosure.

Examples may include a seal member. A seal member may be internal to the base. A seal member may be situated between the base and the thread cap to improve sealing.

In one embodiment, the seal member may include a sealing lower cap, a sealing gel, and a sealing upper cap. The sealing gel may be located between the sealing lower cap on one end and the sealing upper cap on the other end. The seal member may include a bead cap. The seal member may include beads. The beads, in one example, may be steel beads. The beads may be encased between the seal upper cap and the bead cap. The sealing lower cap, sealing gel, the sealing upper cap, beads, and bead cap may be associated with each other to form the seal member. The seal member may fit with the threaded cap. The seal member may snap into the threaded cap.

Certain examples may include a ring. The ring may, in some examples be an O-shaped ring. The ring may be a rubber ring. The ring may fit with a top of the base and be couched between the base and dome when they are interfaced with each other. In some examples, a top of the base is fixedly provided with an O-shaped rubber ring to improve the sealing between the base and the dome.

Embodiments may include a plurality of circular holes on a side of the seal upper cap. The beads may fit in the circular holes. The beads may be movably retained in the circular holes between the seal upper cap and the bead cap. The beads being located between the bead cap and the seal upper cap may reduce friction, with through holes provided on one side of the bead cap. In one example, a diameter of the bead is greater than the diameter of the through hole.

This example may include on a top inner wall of the threaded cap an internal thread portion. The bottom outer end of said base may include an external thread portion. The internal thread portion of the threaded cap and the external thread portion of the base may interface to secure the threaded cap to the base. The threaded cap and the base may be threaded one to the other. The threaded cap may tighten along the interfacing threads and secure the threaded cap to the base.

In one embodiment, when the threaded cap is installed, the threaded cap is drawn toward the base and secured to the base by way of a threaded interface of the internal threads and the external threads. In the process of establishing the threaded interface, the beads may be in contact with an inner wall of the threaded cap, which serves to reduce friction.

The sealing member may include a sealing gel. The sealing member being encased in a main body of the base effectively improving the sealing of the main body of the dome enclosure as to the installed optical fiber cable, waterproofing, and preventing the entry of water into the interior and dome of the dome enclosure. The sealing gel may be engaged when the threaded cap interfaces with the base and the base interfaces with the dome. The sealing of an O-type adhesive ring between the base and the dome may effectively improve the sealing between the base and the dome. The sealing gel thus engaged between the seal upper cap and the seal lower cap.

Some embodiments include a waterproof dome enclosure including a sealing mechanism through the sealing member, the sealing of the main body of the enclosure effectively improved by way of the process of attaching the base to dome and the threaded cap to the base. Waterproofing is obtained, with water prevented from entering into the interior of the main body of enclosure.

One embodiment includes a dome enclosure having a toolless closure. In some examples a base includes a threaded cap. The threaded cap may secure the base to the cap by way of an interface between the internal threads and the external threads. The interface between the internal threads and the external threads may form a waterproof seal between the dome and the base. The interface between the internal threads and the external threads may form a waterproof seal between the dome and the base and include a toolless access that does not require a tool to remove the thread cap and/or to access the internal portion of the enclosure, for example to add or remove additional cable.

The interface between the internal threads and the external threads may form a waterproof seal without the requirement for a tail extending beyond a plane formed along the terminal end of the thread cap. Other embodiments may include a dome enclosure that is tailless. The interface between the internal threads and the external threads may form a waterproof seal at the seal mechanism, for example, at the base and the thread cap. The thread cap may overlap the walls extending from the base.

Many conventional dome enclosures require a key or tool for re-entry of the enclosure. A key, extension piece and/or a tool each and all create challenges in handling re-entry of the enclosure while in heavy gloves. Also, such additional key, extension pieces, a tail, and/or tools get in the way and create tangles and bulk, for example, when servicing and/or adding cable to a dome enclosure. In certain embodiments, inventions of the present disclosure overcome these and other challenges and may include a thread cap seal mechanism, that does not require a tool and/or a tail, extension piece, for operation, and/or re-entry into the enclosure. Cables typically extend from the base end of a dome enclosure and required entry/access medially through the extending cables is conventionally cumbersome and time-consuming.

Embodiments of a dome enclosure may include a screw-on seal mechanism. The thread cap may screw onto/off the base. The seal mechanism may provide a compressing force on a seal member. A threaded cap may be screwed on to walls extending from the base and provide a compressing force on the seal member, the compressing force pressing inward, toward the enclosure, along an inner perimeter of the base walls. A compression along the inner perimeter of the base walls provides greater surface area contact for the compressive force and resulting compression. The compression along the inner perimeter of the base walls provides greater surface area contact for the compressive force and resulting compression as opposed to a compressive force originating medially, and/or along a central part of the base. The compression may be a threaded compression. The threaded cap may provide a threaded compression to the seal member. The threaded compression may be along an inner perimeter of the base wall. The threaded compression may be along an outer perimeter face of the seal member.

In certain examples, a thread cap may be hand-tightened to provide a compression along an outer perimeter face of the seal member to create a waterproof seal at a base of a dome enclosure. The thread cap may be hand tightened and locked in place for a water sealing process and method.

The seal member may include a sealing gel member. The sealing gel member may be removable. The sealing gel member may be removable and/or replaceable from the dome enclosure. The sealing member may, in some examples include a hinge, about which the sealing member may be hinged open with at least two portions of the sealing member hingedly attached to one another. The sealing member may include an articulating joint about which the sealing member may be opened.

The above summary was intended to summarize certain embodiments of the present disclosure. Embodiments will be set forth in more detail in the figures and description of embodiments below. It will be apparent, however, that the description of embodiments is not intended to limit the present inventions, the scope of which should be properly determined by the appended claims.

### BRIEF DESCRIPTION OF THE DRAWINGS

The accompanying drawings, which are incorporated in and constitute a part of this disclosure, illustrate various embodiments of the present disclosure. The drawings may contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

The drawings, photographs, pictures, and the like may contain text or captions that may explain certain embodiments of the present disclosure. This text is included for illustrative, non-limiting, explanatory purposes of certain examples and elements detailed in the present disclosure.

Embodiments of the disclosure will be better understood by a reading of the Description of Embodiments along with a review of the drawings, in which:

FIG. 1 is a perspective view of a dome enclosure according to an embodiment of the disclosure;

FIG. 2 is an alternate perspective view of a dome enclosure according to an embodiment of the disclosure;

FIG. 3 is a perspective view of the dome enclosure according to FIG. 1 showing a separation of a dome and a base according to one example of the disclosure;

FIG. 4 is an exploded view of the dome enclosure of FIG. 1 according to one example of the disclosure;

FIG. 5 is a cutaway view of the dome enclosure of FIG. 1 according to one example of the disclosure;

FIG. 6 is a cutaway view of the base of a dome enclosure according to FIG. 1 according to one example of the disclosure;

FIG. 7 is an alternate cutaway view of the base of a dome enclosure according to one example of the disclosure;

FIG. 8A is an exploded view of the base of a dome enclosure according to one example of the disclosure;

FIG. 8B is a reversed and further exploded view of the base of a dome enclosure according to FIG. 8A;

FIG. 9 is a close up view of the base of the dome enclosure according to embodiments of disclosure;

FIG. 10 is a perspective view of a dome enclosure according to an embodiment of the disclosure;

FIG. 11 is a perspective view of one example of a seal member according to an embodiment of the present disclosure;

FIG. 12 is a perspective view of one example of an articulating seal member according to an embodiment of the present disclosure;

FIG. 13 is an alternative view of one example of an articulating seal member according to an embodiment of the present disclosure;

FIG. 14 is a side exploded view of one example of a dome enclosure according to an embodiment of the present disclosure;

FIG. 15 is a perspective side view of one example of a dome enclosure with the dome removed, according to an embodiment of the present disclosure;

FIG. 16 is a perspective top view of one example of a dome enclosure with the dome removed, according to an embodiment of the present disclosure;

FIG. 17 is a close up view of an inside of a dome of the dome enclosure, according to an embodiment of the present disclosure; and

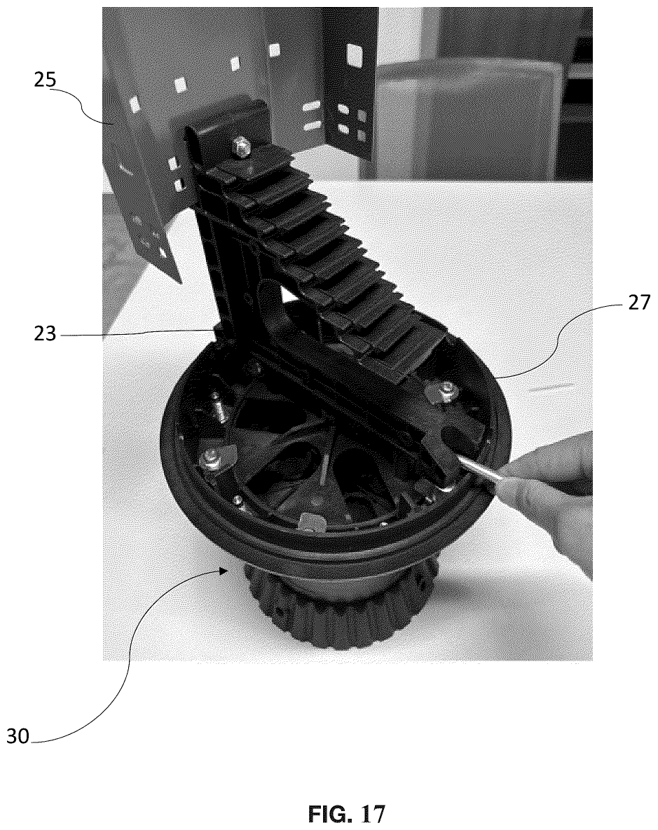

FIG. 18 is another close up view of an inside of a dome of the dome enclosure according to an embodiment of the present disclosure.

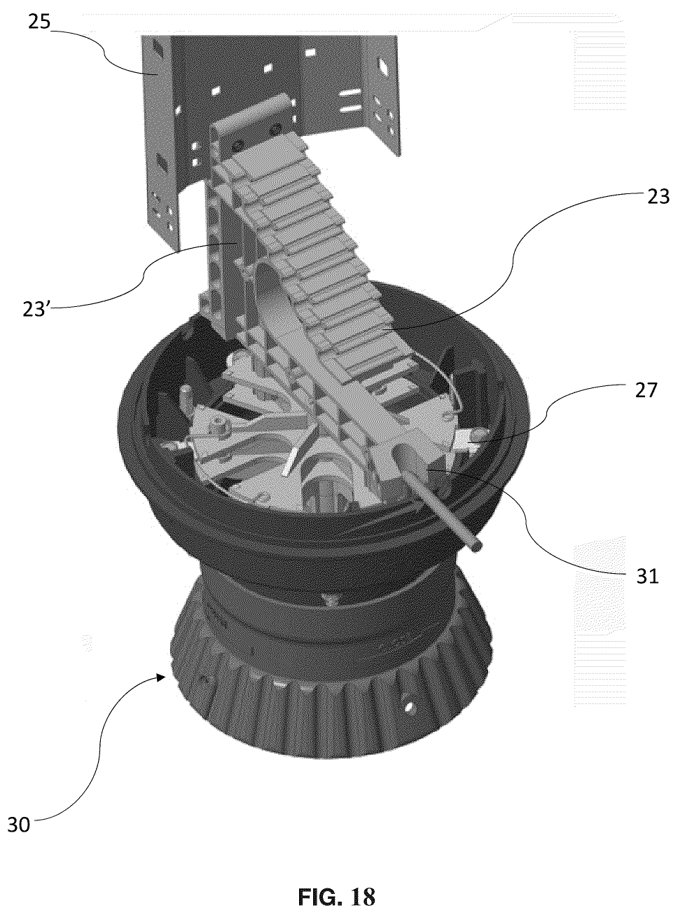

### DESCRIPTION OF EMBODIMENTS

In the following description, like reference characters designate like or corresponding parts throughout the several views. Also in the following description, it is to be understood that such terms as “forward,” “rearward,” “left,” “right,” “upwardly,” “downwardly,” and the like are words of convenience and are not to be construed as limiting terms.

It will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified may be considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Certain examples and elements are described herein in detail in relation to one or more embodiments, it is to be understood that this disclosure is illustrative and exemplary of the present disclosure and are made merely to provide a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

The following detailed description refers to the accompanying drawings, photographs, pictures, and the like. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that the headers are used as references and are not to be construed as limiting upon the subject matter disclosed under the header.

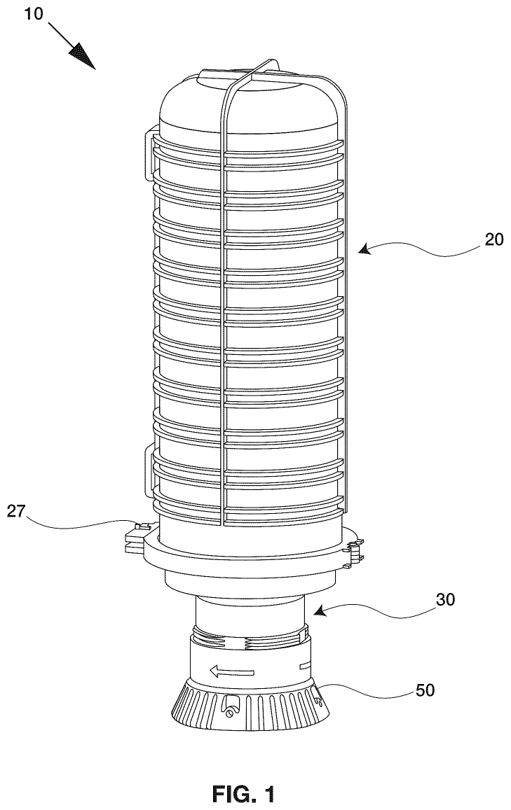

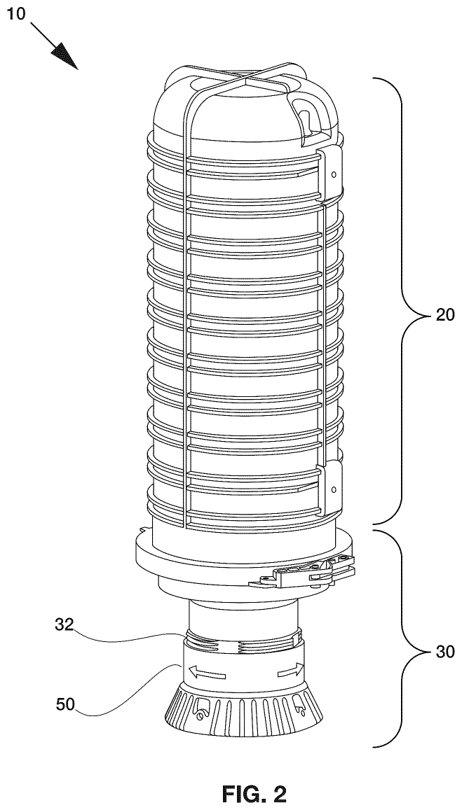

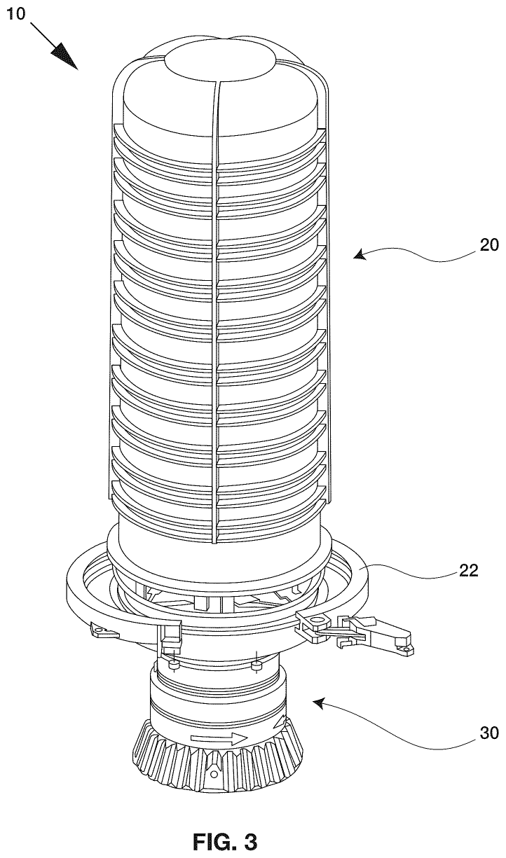

Referring now to the drawings in general, it will be understood that the illustrations are for the purpose of describing embodiments of the disclosure and are not intended to limit the disclosure or any invention thereto. FIGS. 1-3 show examples of an enclosure 10 (by way of example a dome enclosure) including a dome 20, and a base 30, the base 30 having a base member 29 and a cap 50. The cap may be a threaded cap 30. The base 30 may be fixed on the dome 20, by way of example, by a bolt and/or screw 27. The thread cap 50, may be located at a bottom end of the base, for example base member 29, and may attach to the base 30. In certain examples, the dome 20 may be affixed to the base 30. The base 30 may be affixed to the thread cap 50 on an opposite side of the base interface than the dome 20. The dome 20 may make up an upper portion of the dome enclosure. The base may make up an intermediate portion of the dome enclosure. The thread cap may make up a lower portion of the dome enclosure.

A clamp 22 may assist in securing the base 30 to the dome 20.

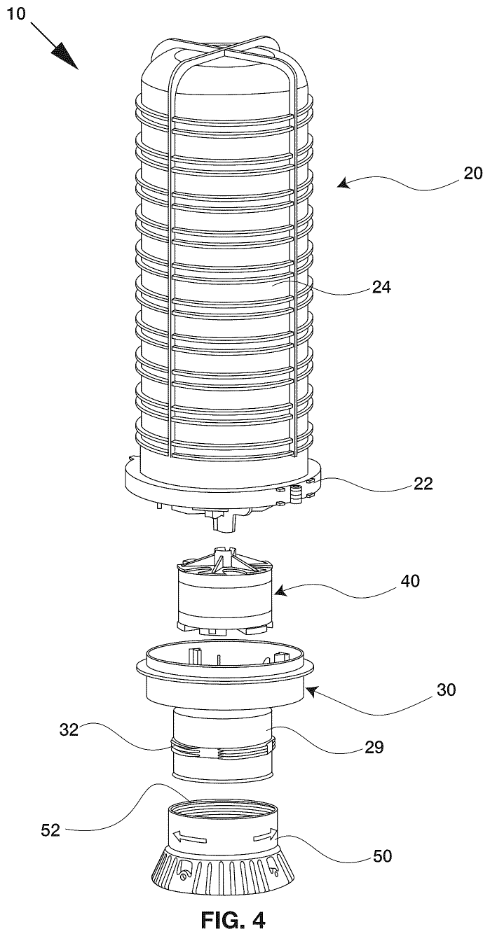

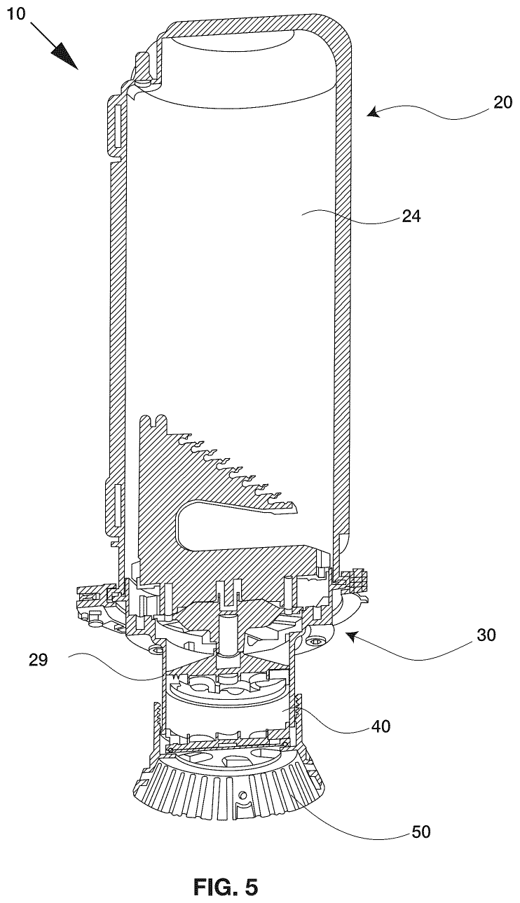

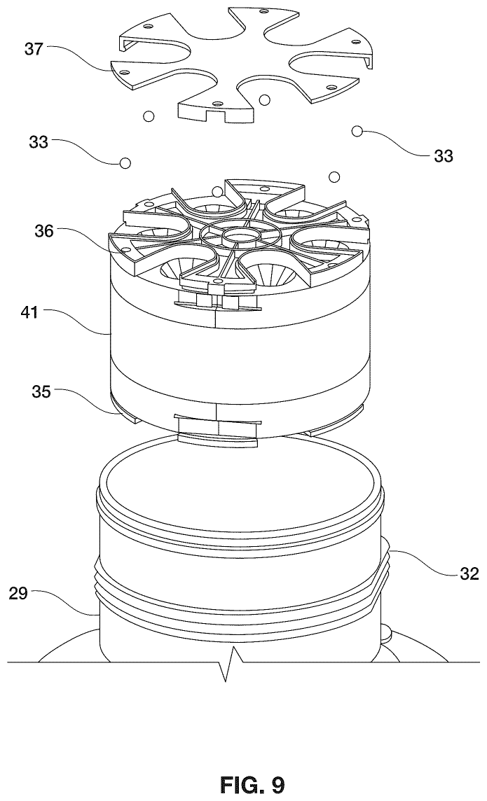

FIGS. 4 and 5 show an exploded view and a cut away view of one example of a dome enclosure 10. Dome 20 may include a main body 24. Dome enclosure 10 may include a seal member 40. The seal member 40 may be enclosed inside the base 30. The seal member 40 may include a sealing gel 41 (see FIG. 9).

Examples may include a threaded cap 50, with threaded cap 50 having along a top inner wall of the threaded cap 50 an internal threaded portion 52. The bottom outer end of the base 30 at base member 29 may include an external thread portion 32. The internal thread portion 52 of the threaded cap 50 and the external thread portion 32 of the base 30 may interface to secure the threaded cap to the base. The threaded cap 50 and the base 30 may be threaded one to the other. The threaded cap 50 may tighten along the interfacing threads and secure the threaded cap 50 to the base 30.

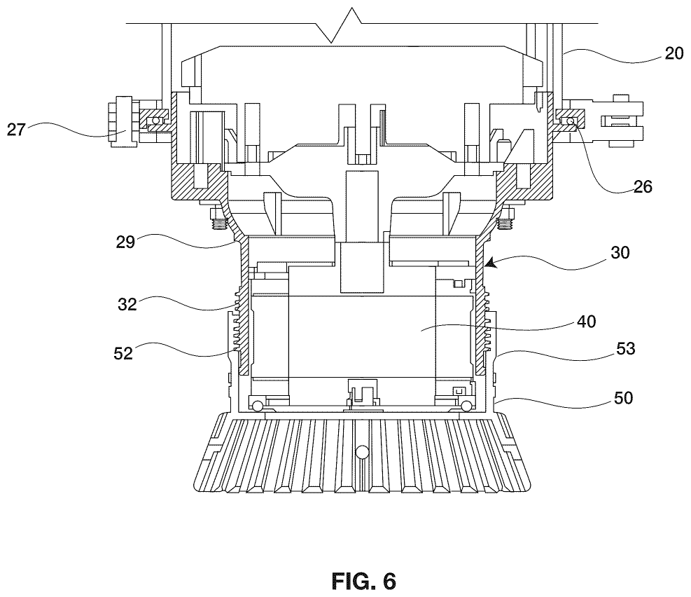

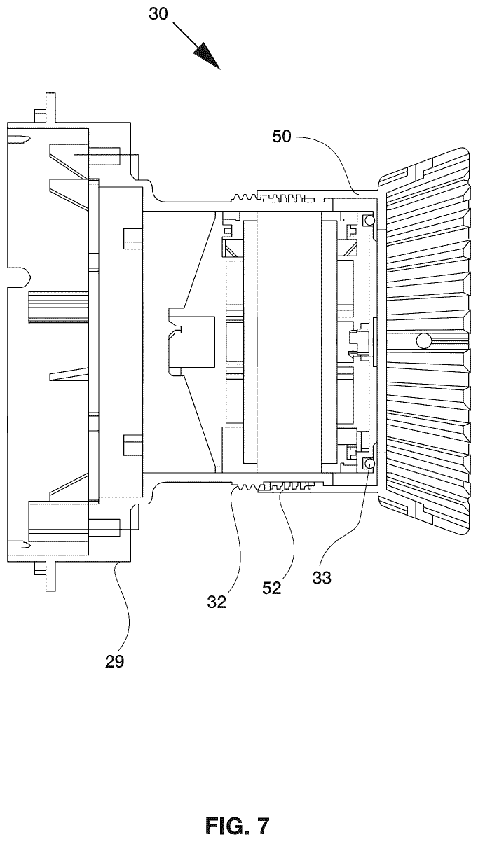

FIGS. 6 and 7 show close-up cut away views of the interaction of one embodiment of a base 30 and a threaded cap 50. The external threads 32 are seen interfacing with the internal threads 52, the aligning threaded portions bringing outer walls 53 of the threaded cap 50 overlapping with walls of the base member 29. The dome enclosure 10 may include a ring 26. The ring may be a rubber ring. The ring may be an adhesive ring. The ring may be an O-type adhesive ring located between the base 30 and the dome 20, and may effectively improve the sealing between the base and the dome. The seal member 40 may be enclosed within the base 30 along the interface of the external threads 32 and the internal threads 52.

Beads 33 may be included in the base 30. In one embodiment, when the threaded cap 50 is installed, the threaded cap 50 is drawn toward the base 30 and secured to the base 30 by way of a threaded interface of the internal threads 52 and the external threads 32. In the process of establishing the threaded interface, the beads 33 may be in contact with an inner wall of the threaded cap 50, which serves to reduce friction.

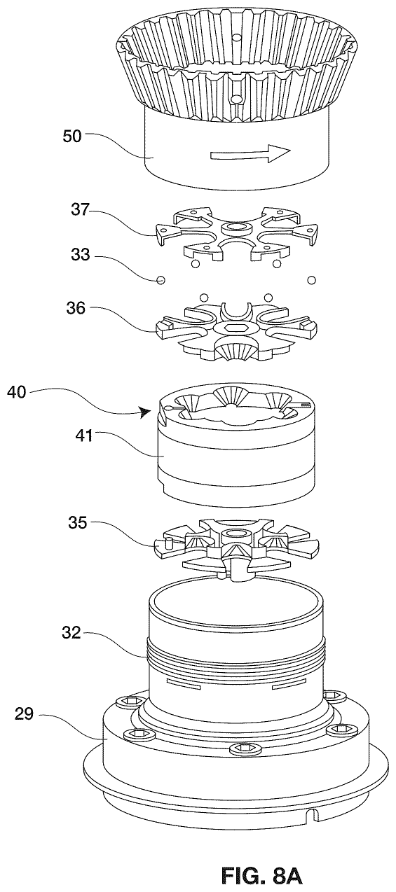

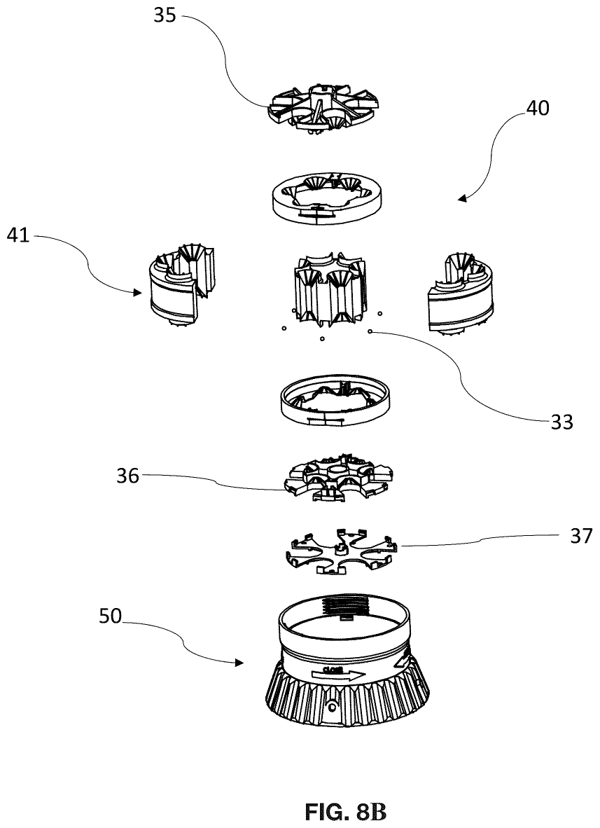

FIGS. 8A, 8B, and 9 show exploded views of the base 30, seal member 40 and threaded cap 50. Seal member 40 may include a sealing lower cap 35, a sealing gel 41, and sealing upper cap 36. Sealing gel 41 may be surrounded by sealing lower cap 35 on one side and sealing upper cap 36 on an opposite side. Embodiments may include a plurality of circular holes on a side of the seal upper cap 36. The beads 33 may fit in the circular holes. The beads 33 may be movably retained in the circular holes between the seal upper cap 36 and the bead cap 37. The beads 33 being located between the bead cap 37 and the seal upper cap 36 may reduce friction, with through holes provided on one side of the bead cap 37. In one example, a diameter of the bead is greater than the diameter of the through hole, in some examples, so that the bead 33 is movably secured within and does not leave the bead cap 50 or the sealing upper cap 35. There may be a seal buckle in the threaded cap 50. Parts of the base may include notches that mate with projections on interfacing parts that fit one with another to lock parts into place when the base is assembled.

Threaded cap 50 connects with base 30 for easy on and off of threaded cap 50, resulting in easy installation of cable, for example easy installation of cable at different times.

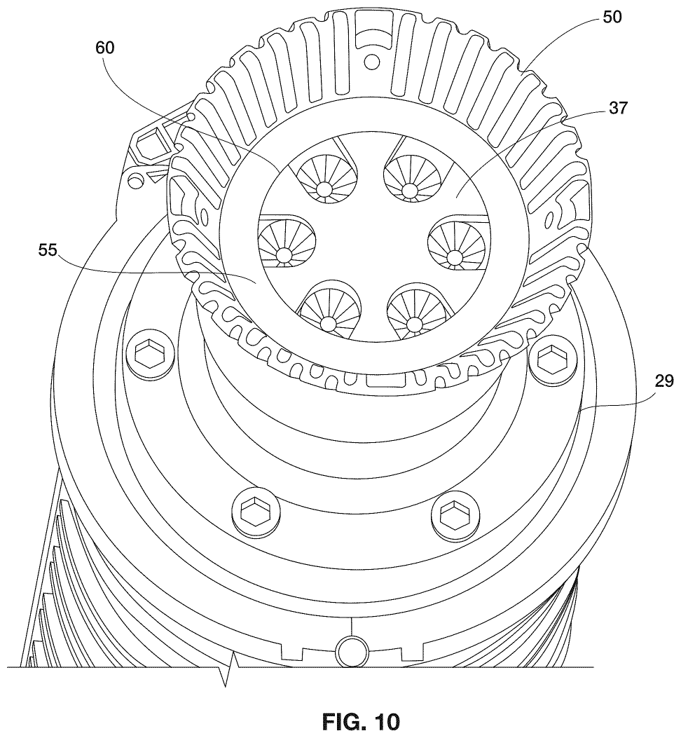

Referencing FIG. 10, a threaded cap 50 may have a central opening 60. When threaded cap 50 is attached to dome enclosure 20, at least a portion of the bead cap 37 may be visible through central opening 60. A rim 55 may partially cover bead cap 37.

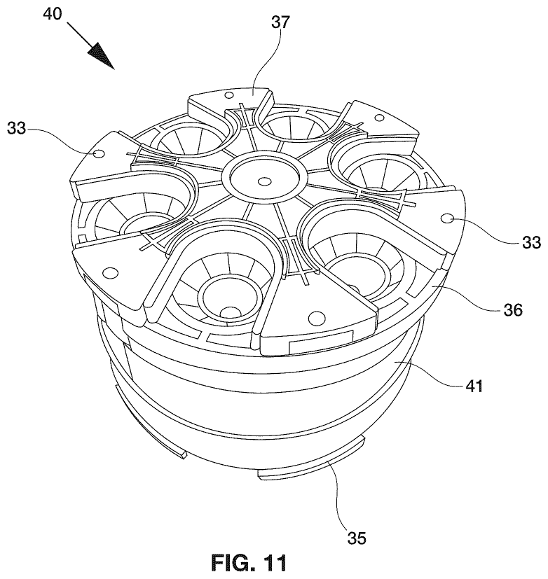

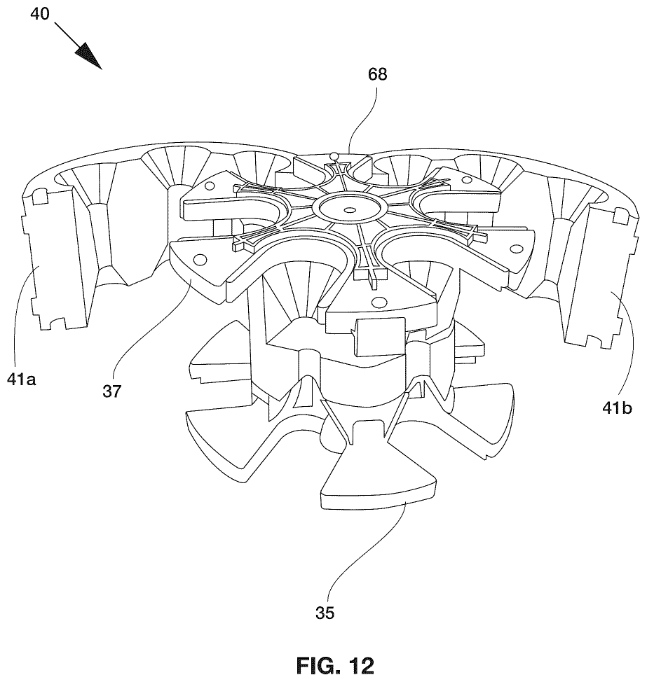

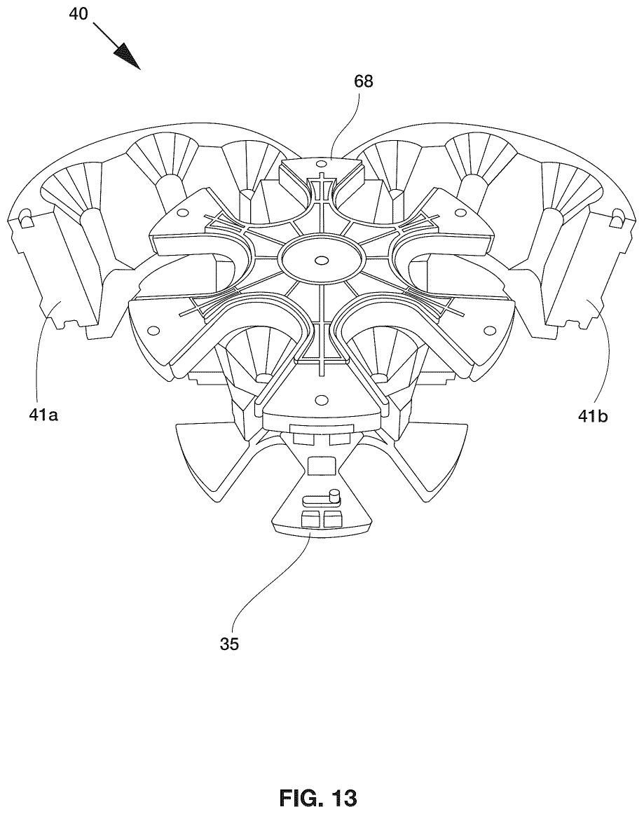

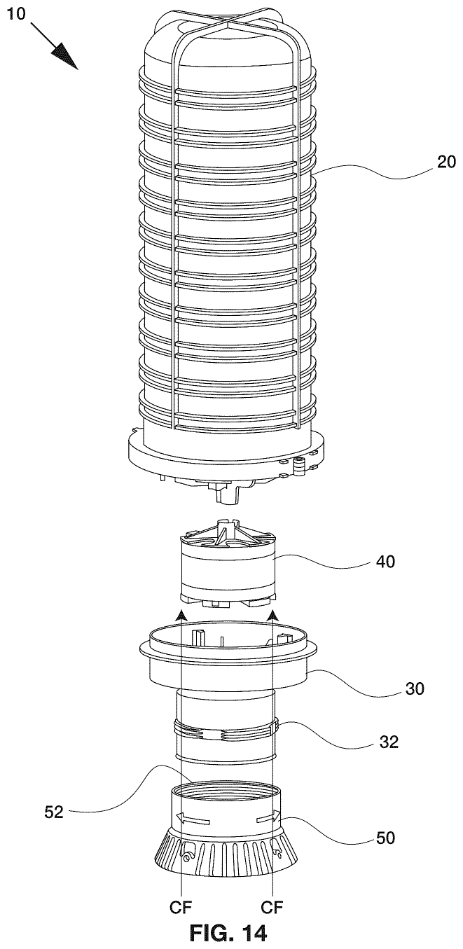

Figures generally, and specifically FIGS. 11-14 show embodiments of a sealing member 40. Sealing member 40 may include a sealing gel 41. The sealing member 40 being encased in a main body of the base 30, effectively improving the sealing of the main body of the dome enclosure as to the installed optical fiber cable, waterproofing, and preventing the entry of water into the interior and dome of the dome enclosure 10. The sealing gel 41 may be engaged when the threaded cap interfaces with the base 30 and the base interfaces with the dome 20. The sealing of an O-type adhesive ring between the base and the dome may effectively improve the sealing between the base and the dome. The sealing gel thus being engaged between a seal upper cap and a seal lower cap.

Some embodiments include a waterproof dome enclosure 10 including a sealing mechanism through the sealing member 40, the sealing of the main body of the enclosure effectively improved by way of attaching the base 30 to dome 20 and the threaded cap 50 to the base 30. Waterproofing is obtained, with water prevented from entering into the interior of the main body of enclosure.

One embodiment includes a dome enclosure 10 having a toolless waterproofing seal/connection. In some examples, a base 30 includes a threaded cap 50. The threaded cap 50 may secure the base 30 to the threaded cap by way of an interface between the internal threads 52 and the external threads 32. The interface between the internal threads 52 and the external threads 32 may form a waterproof seal between the dome and the base. The interface between the internal threads 52 and the external threads 32 may form a waterproof seal between the dome and the base and include a toolless access that does not require a tool to remove the thread cap and/or to access the internal portion of the enclosure, for example to add or remove additional cable.

The interface between the internal threads 52 and the external threads 32 may form a waterproof seal without the requirement for a tail (not shown) extending beyond a plane formed along the terminal end of the thread cap 50. Other embodiments may include a dome enclosure that is tailless. The interface between the internal threads 52 and the external threads 35 may form a waterproof seal at the seal mechanism, for example, at the base 30 and the thread cap 50. The thread cap 50 may overlap the walls extending from the base member 29.

Many conventional dome enclosures require a key, tail, or tool for re-entry of the enclosure. A key, tail, extension piece and/or a tool each and all create challenges in handling re-entry of the enclosure while in heavy gloves. Also, such additional key, extension pieces, a tail, and/or tools get in the way and create tangles and bulk, for example, when servicing and/or adding cable to a dome enclosure. In certain embodiments, inventions of the present disclosure overcome these and other challenges and may include a thread cap seal mechanism, that does not require a tool and/or a tail, extension piece, for operation, and/or re-entry into the enclosure. Cables extending from the base end of conventional dome enclosures that require entry/access medially through the extending cables is cumbersome and time-consuming.

Embodiments of a dome enclosure 10 may include a screw-on seal mechanism. The thread cap 50 may screw onto/off the base 30. The seal mechanism, in some examples, including combinations of parts of the base 30 may provide a compressing force on a seal member 40. A threaded cap 50 may be screwed on to walls extending from the base 30, base member 29, and provide a compressing force on the seal member 40, the compressing force pressing inward, toward the dome 20, along an inner perimeter of the base walls, see compression force CF. A compression along the inner perimeter of the base walls provides greater surface area contact for the compressive force CF and resulting compression. The compression along the inner perimeter of the base walls of the base member 29 provides greater surface area contact for the compressive force CF and resulting compression as opposed to a compressive force originating medially, and/or along a central part of the base. The compression may be a threaded compression. The threaded cap 50 may provide a threaded compression to the seal member 40. The threaded compression may be along an inner perimeter of the base wall. The threaded compression may be along an outer perimeter face of the seal member 40.

Embodiments may include a compressive surface in the threaded cap 50. In one example the compressive surface may maximize compressive surface area while also maintaining an opening for contents of the enclosure to pass through. The compressive surface may form a compression plane extending along an inner rim of the threaded cap 50.

A compression plane may exert a compressive force from the cap 50, along a perimeter of the seal member 40 such that the compressive force extends upward and inward toward the sealing member from the perimeter of the sealing gel 41, spreading and compressing the sealing gel around entering cable and/or enclosure 10 contents. The inward, from the perimeter compressive force CF may provide a more secure and repetitive seal to the enclosure. This structure also produces an unobstructed access to seal member 40.

Examples may include a cap 50 having a rim 55. The rim 55 including an internal opening that is unobstructed. In some embodiments, the rim around an inner perimeter of the cap includes an unobstructed opening that is not obstructed by components of the seal member 40. The plane of the rim may allow for inserted cables to pass through the unobstructed opening.

In certain examples, a thread cap 50 may be hand-tightened to provide a compression along an outer perimeter face of the seal member 40 to create a waterproof seal at the base of a dome enclosure. The thread cap 50 may be hand tightened and locked in place for a water sealing process and method.

The seal member 40 may include a sealing gel 41. The sealing gel and/or sealing member may be removable. The sealing gel and/or sealing member may be removable and/or replaceable from the dome enclosure 10. The sealing member 40 may, in some examples include a hinge 68, about which the sealing gel 41 may be hinged open with at least two portions of the sealing gel 41a and 41b hingedly attached to one another. The sealing member may include an articulating joint at hinge 68 about which the sealing gel may be opened.

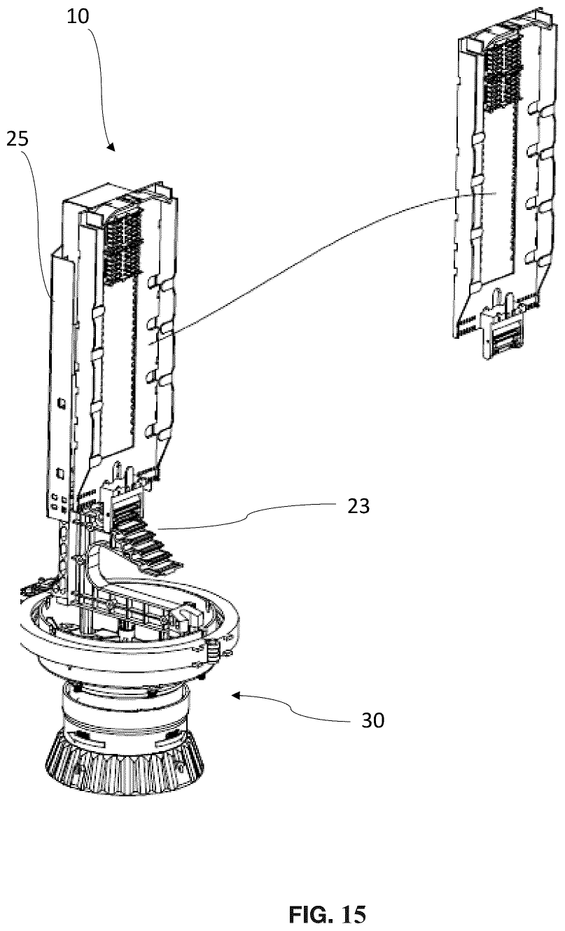

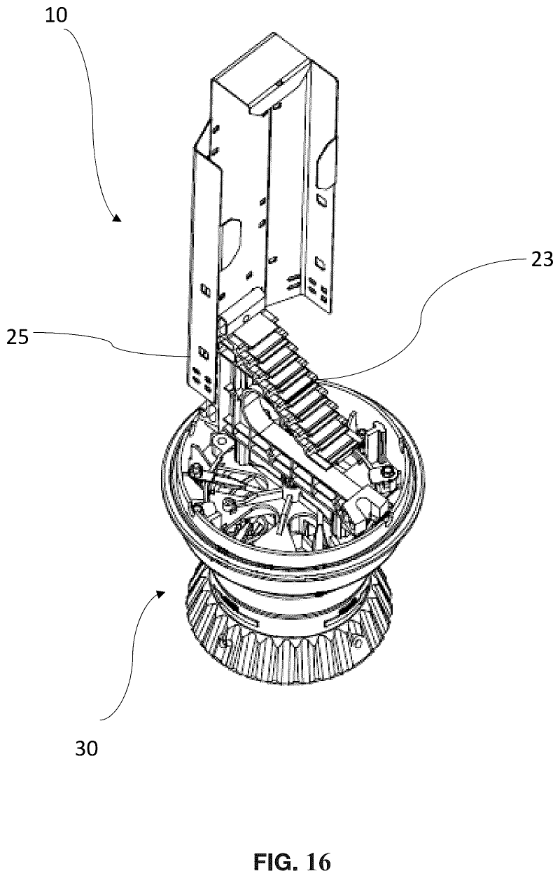

FIGS. 15-16 show examples of an inside of an enclosure 10 with a dome 20 removed. An internal portion of the dome 20 may include a backplate 25 supported by a tray 23. Backplate 25 may provide a housing for a splicing tray. Tray 23 may include a spine 23′ that aligns with backplate 25. An attachment, by way of example, a screw, bolt, ledge, recess (by way of example between ledge projections), and/or hook may secure the spine 23′ and the backplate 25.

A base 20 may be a base assembly. A portion of the base assembly may be an anchor 27 for the dome on an upper side of the base assembly. The cap 20 may be in removable attachment with the base. The cap 20 may screw onto the base assembly. The tray 23 may secure with the anchor 27. In some examples, the tray 23 may screw and/or bolt to the anchor 27. A passageway 31 in the tray 23 may provide access to one or more attachments securing the tray 23 to the anchor 27.

Example inventions of the present disclosure include dome-type enclosures with improved waterproofing seal. In one embodiment, the invention may be considered a waterproof sealing mechanism for dome enclosures.

Methods for waterproofing a dome enclosure according to any of the embodiments or combination of embodiments herein is considered within the scope of the disclosure. Methods for waterproofing a resealable dome enclosure are considered with the scope of the disclosure.

Systems for a sealable and/or waterproof dome enclosure according to any of the embodiments or combination of embodiments herein is considered within the scope of the disclosure.

Those of ordinary skill in the art having the benefit of this disclosure will recognize that a variety of other examples include a variety of shapes, styles, and sizes and assemblies for the convenience of its user.

The foregoing may depict an example of a method, of a plurality of methods, that may be performed by at least one of the aforementioned embodiments, or components thereof. Further, although the elements here may be disclosed in a particular order, it should be understood that the order is disclosed for illustrative purposes only. Elements may be combined, separated, reordered, and various intermediary stages may exist. Accordingly, it should be understood that the various assemblies, in various embodiments, may be performed/assembled in orders that differ from the ones disclosed. Moreover, various stages may be added or removed without altering or departing from the fundamental scope of the depicted methods and systems disclosed herein.

The above overview, summary, and the detailed description provide examples and are explanatory only. Accordingly, the foregoing overview and the detailed description should not be considered to be restrictive. Further, features or variations may be provided in addition to those set forth herein. For example, embodiments may be directed to various feature combinations and sub-combinations described in the summary and detailed description.

In some embodiments, the disclosure includes a dome enclosure kit. The kit may provide a waterproof dome enclosure for cable as shown and described herein. The kit may include a dome, a base and a threaded cap, for example, any of the embodiments or combination of embodiments previously shown or described. It is contemplated that the embodiments extend to any enclosure and are not limited to dome enclosures.

Various hardware components and elements may be employed at the various stages of operations disclosed, in any order, with reference to each example and embodiment. Further, consistent with embodiments of the present disclosure, a method may be performed by at least one of the aforementioned examples, assemblies, and/or combination of assemblies.

Numerous characteristics and advantages have been set forth in the foregoing description, together with details of structure and function. Many of the novel features are pointed out in the appended claims. The disclosure, however, is illustrative only, and changes may be made in detail, especially in matters of shape, size, and arrangement of parts, within the principle of the disclosure, to the full extent indicated by the broad general meaning of the terms in which the general claims are expressed. It is further noted that, as used in this application, the singular forms “a,” “an,” and “the” include plural referents unless expressly and unequivocally limited to one referent.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges subsumed therein, and every number between the end points. For example, a stated range of “1 to 10” should be considered to include any and all subranges between (and inclusive of) the minimum value of 1 and the maximum value of 10; that is, all subranges beginning with a minimum value of 1 or more, e.g. 1 to 6.1, and ending with a maximum value of 10 or less, e.g., 5.5 to 10, as well as all ranges beginning and ending within the end points, e.g. 2 to 9, 3 to 8, 3 to 9, 4to 7, and finally to each number 1, 2, 3, 4, 5, 6, 7, 8, 9 and 10 contained within the range.

Any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth.

Elements and terms used herein refer to that which one of ordinary skill would understand such a term to mean based on the contextual use of the term herein. To the extent that the meaning of a term used herein—as understood by the ordinary artisan based on the contextual use of such term—differs in any way from any particular dictionary definition of such term, it is intended that the meaning of the term as understood by one of ordinary skill should prevail.

Regarding applicability of 35 U.S.C. § 112, ¶6, no claim element is intended to be read in accordance with this statutory provision unless the explicit phrase “means for” or “step for” is actually used in such claim element, whereupon this statutory provision is intended to apply in the interpretation of such claim element.

All rights, including copyrights herein, are vested in and the property of the Applicant.

The specification includes examples, the disclosure's scope is indicated by the following claims, and furthermore, while the specification has been described in language specific to structural features and/or methodological acts, the claims are not limited to the features or acts described above. Rather, the specific features and acts described above are disclosed as examples for embodiments of the disclosure. Insofar as the summary and description above and the accompanying drawing disclose any additional subject matter that is not within the scope of the claims below, the disclosures are not dedicated to the public and the right to file one or more applications to claims such additional disclosures is reserved.

What is claimed is:

1. An enclosure comprising:
a dome, and
a base that mates with the dome, and
a seal member,
wherein the base includes a thread cap structured to enable a hand-tightening, including a compression occurring along a perimeter face of a seal member to create a waterproof seal for the dome enclosure.

2. The enclosure of claim 1, wherein the base includes a sealing gel member.

3. The enclosure of claim 2, including a sealing gel.

4. The enclosure of claim 3, including a toolless closure.

5. The enclosure of claim 3, wherein the thread cap includes an internal threads.

6. The enclosure of claim 5, wherein a base member includes an external threads.

7. The enclosure of claim 6, wherein internal threads and the external threads interface to screw-on the thread cap onto the base.

8. The enclosure of claim 7, wherein screwing-on the thread cap creates a compressive force on the gel member.

9. The enclosure of claim 8 wherein the compressive force is actuated on the gel member around an outside perimeter rim of the gel member.

10. The enclosure of claim 9 wherein the compressive force is exerted along an inside perimeter of the base.

11. The enclosure of claim 3 including a sealing lower cap, a sealing upper cap, and a bead cap.

12. The enclosure of claim 11 including beads that are movably retained between the bead cap and the seal upper cap.

13. The enclosure of claim 3 wherein the sealing gel is removable and replaceable.

14. The enclosure of claim 3, wherein the seal member includes an articulating joint that allows the sealing gel to be divided into two portions, the two portions adapted to hinge open away from one another at a separating plane.

15. The enclosure of claim 3, wherein the base is a tailless base.

16. The enclosure of claim 3 wherein a compression plane is formed within the thread cap.

17. An enclosure comprising:
a dome,
a base assembly attached to the dome, the base assembly including:
a base member,
a cap, and
a seal member including:
a sealing gel,
a sealing upper cap,
a sealing lower cap, and
a bead cap,
wherein the base forms a watertight seal for the enclosure when the cap is attached to the base.

18. The enclosure of claim 17 wherein the enclosure is a waterproof dome enclosure including a waterproof containment of optical cable.

19. The enclosure of claim 18, including a screw-on seal mechanism in the base assembly, wherein the base assembly includes a base member, and a seal member that encases inside the base member and the threaded cap.

20. A system for waterproofing a cable enclosure comprising:
mating a dome with a base assembly,
housing in the base assembly a base member,
fitting a cap with the base assembly,
providing a seal member with a sealing gel, and
providing a watertight seal for the enclosure when a threaded cap is attached to the base.
